(19) United States
(12) Patent Application Publication
(10) Pub. No.: US 2026/0249750 A1
(43) Pub. Date: Aug. 27, 2026

(54) VEHICLE SEAT, ESPECIALLY FOR AN AUTONOMOUSLY DRIVING MOTOR VEHICLE

(71) Applicant: Adient US LLC, Plymouth, MI (US)

(72) Inventors: Thomas DILL, Heiligenmoschel (DE); Christian KAUFHOLD-HAFFNER, Kaiserslautern (DE); Christian WOLF, Dielkirchen (DE); Christian JANNECK, Kaiserslautern (DE)

(21) Appl. No.: 19/160,207

(22) PCT Filed: Nov. 22, 2023
(86) PCT No.: PCT/IB2023/061784

§ 371 Date: Aug. 27, 2025

(30) Foreign Application Priority Data
Feb. 28, 2023 (DE) 10 2023 104 940.2
Feb. 28, 2023 (DE) 10 2023 104 941.0

(51) Int. Cl. B60N 2/18; B60N 2/10; B60N 2/427

(52) U.S. Cl. CPC B60N 2/181; B60N 2/10; B60N 2/42709

(57) ABSTRACT

A vehicle seat for an autonomously driving motor vehicle may have a setting kinematics system. The setting kinematics system may have a first gear mechanism member and a second gear mechanism member, which may be adjustable relative to one another by means of an actuating drive. The actuating drive or one of the two gear mechanism members may be connected to a slide. A blocking device may lock the slide relative to a further component of the vehicle seat. In the event of an overload acting on the vehicle seat the blocking device may enable a relative displacement between the slide and the further component of the vehicle seat.

The invention relates to a vehicle seat, in particular for an autonomously driving motor vehicle, comprising an adjustment kinematics system, the adjustment kinematics system comprising a first transmission element and a second transmission element, which are adjustable, in particular pivotable, relative to one another by means of an actuating drive.

### PRIOR ART

DE 10 2018 122 198 A1 discloses an actuating drive for a motor vehicle, in particular for a motor vehicle seat, having an electric motor, which has an output shaft; a transmission, which has a spindle nut and a transmission housing and is connected to the output shaft; having a spindle, which is in engagement with the spindle nut, and having a holder, which at least partially surrounds the transmission housing.

WO 2020/207835 A1 discloses a vehicle seat having a height adjustment kinematics system, the height adjustment kinematics system having a four-bar assembly and an adjustment arm on each of two seat sides offset relative to one another in a transverse direction, each of the two four-bar assemblies having a base, a side part, a front rocker and a rear rocker as transmission elements of the four-bar assembly, wherein a first pivot joint connects the base pivotably to the rear rocker, a second pivot joint connects the rear rocker pivotably to the side part, a third pivot joint connects the side part pivotably to the front rocker, and a fourth pivot joint connects the front rocker pivotably to the base, wherein each of the two four-bar assemblies can be set by means of one of the two adjustment arms, wherein a driving device having precisely one geared motor drives the two adjustment arms.

WO 2020/114946 A1 discloses a longitudinal adjuster for a vehicle seat having at least one rail pair, which has a seat rail, which can be connected to the vehicle seat, and a floor rail, which can be connected to a vehicle floor and on which the seat rail is guided in a manner that allows movement along a longitudinal direction. The longitudinal adjuster has a driving device for adjusting the seat rail along the longitudinal direction relative to the floor rail, wherein the driving device has a spindle fixed with respect to the floor rail or with respect to the seat rail, a rotatable spindle nut supported on the spindle by thread engagement, and an electric motor, operatively connected to the spindle nut, for driving the spindle nut. An output shaft on the driven side of the electric motor is oriented parallel to the spindle.

In an autonomously driving motor vehicle, a vehicle driver does not have to or does not continuously have to perform steering and/or braking or acceleration actions during the operation of the motor vehicle; on the contrary, the motor vehicle can be operated independently of the actions of a vehicle driver. The vehicle driver can therefore assume a more comfortable position during autonomous driving than is the case with conventional vehicles. DE 10 2018 203 731 A1 discloses a vehicle seat, in particular for an autonomously driving motor vehicle, which can assume an inclined position in which a seating surface and a seat back have an angle which allows a predominantly recumbent position of the vehicle occupant during an autonomous driving mode. In an upright position of the vehicle seat, the vehicle driver can take over vehicle guidance if the autonomous driving mode is switched off.

German Patent Application 10 2022 119 627.5, which is a later publication, discloses a vehicle seat, in particular for an autonomously driving motor vehicle, the vehicle seat having a seat substructure and a seat back articulated on the seat substructure, the seat substructure having a base, a seat frame and an adjustment kinematics system acting between the base and the seat frame, wherein the adjustment kinematics system is embodied as a five-bar kinematics system.

### Problem

It is the underlying object of the invention to provide a vehicle seat, in particular for an autonomously driving motor vehicle, which can assume an inclined position in which a seating surface and a seat back have an angle which allows a predominantly recumbent position of a vehicle occupant, in particular a vehicle driver, in particular in an autonomous driving mode. The vehicle seat should offer the possibility of moving quickly back out of the inclined position into another inclined orientation in the event of a crash in order to reduce any harmful effects on the occupant.

### Solution

According to the invention, this object is achieved by a vehicle seat, in particular for an autonomously driving motor vehicle, comprising an adjustment kinematics system, the adjustment kinematics system comprising a first transmission element and a second transmission element, which are adjustable, in particular pivotable, relative to one another by means of an actuating drive, wherein the actuating drive or one of the two transmission elements is connected to a slide, wherein a blocking device locks the slide relative to a further component of the vehicle seat, in particular relative to a base of the vehicle seat, and, in the event of an overload, in particular a crash load, acting on the vehicle seat, the blocking device enables a relative movement between the slide and the further component of the vehicle seat. Locking can comprise form-fitting and/or force-fitting and/or materially bonded connection. The relative movement can be enabled, for example, by the exceeding of a frictional force and/or by cancellation of a form fit due to deformation.

By virtue of the fact that the actuating drive or one of the two transmission elements is connected to a slide, wherein a blocking device locks the slide relative to a further component of the vehicle seat, in particular relative to a base of the vehicle seat, and, in the event of an overload, in particular a crash load, acting on the vehicle seat, the blocking device enables a relative movement between the slide and the further component of the vehicle seat, the adjustment kinematics system can be adjusted in the event of an overload without the need to actuate the actuating drive.

The vehicle seat can have a seat substructure and a seat back articulated on the seat substructure. The seat substructure can have a base, a seat frame and an adjustment kinematics system acting between the base and the seat frame.

The first transmission element can be designed as a first rocker, in particular as a first front rocker. The second transmission element can be designed as a second rocker, in particular as a second front rocker, which is pivotable relative to the first rocker by means of the actuating drive.

The actuating drive or one of the two rockers can be connected to a slide that can be locked by the blocking device, wherein, in the event of an overload, in particular a crash load, acting on the vehicle seat, the blocking device enables a relative movement between the slide and the base.

The first rocker can be articulated on the base in such a way as to be pivotable about a first axis of rotation. A first end region of the first rocker can be articulated on the base in such a way as to be pivotable about the first axis of rotation.

The second rocker can be articulated on the first rocker in such a way as to be pivotable about a second axis of rotation. A first end region of the second rocker can be articulated on a second end region of the first rocker in such a way as to be pivotable about the second axis of rotation. The second rocker can be articulated on the seat frame in such a way as to be pivotable about a third axis of rotation. A second end region of the second rocker can be articulated on the seat frame in such a way as to be pivotable about the third axis of rotation.

A further rocker, in particular a rear rocker, can be articulated on the seat frame in such a way as to be pivotable about a fourth axis of rotation. A first end region of the further rocker can be articulated on the seat frame in such a way as to be pivotable about the fourth axis of rotation. The further rocker can be articulated on the base in such a way as to be pivotable about a fifth axis of rotation. A second end region of the further rocker can be articulated on the base in such a way as to be pivotable about the fifth axis of rotation.

The first axis of rotation can be arranged below the second axis of rotation. The first axis of rotation can be arranged below the third axis of rotation. The first axis of rotation can be arranged in front of the fourth axis of rotation. The first axis of rotation can be arranged in front of the fifth axis of rotation.

The second axis of rotation can be arranged below the third axis of rotation. The second axis of rotation can be arranged in front of the fourth axis of rotation. The second axis of rotation can be arranged in front of the fifth axis of rotation.

The third axis of rotation can be arranged in front of the fourth axis of rotation. The third axis of rotation can be arranged in front of the fifth axis of rotation. The fifth axis of rotation can be arranged below the fourth axis of rotation.

In order to provide a height adjustment function, in particular, an angle between the first rocker, in particular the first front rocker, and the base as well as an angle between the further rocker, in particular the rear rocker, and the base can be variable by means of a first actuating drive, wherein an angle between the second rocker and the seat frame remains constant.

The first actuating drive can have an electric motor and a transmission. The first actuating drive can have an electric motor, a transmission, a spindle nut and a spindle. The first actuating drive can connect the rear rocker and the base to one another at an adjustable angle. The first actuating drive can connect the further rocker and the base to one another at an adjustable angle and directly, i.e. without the interposition of further transmission elements. A spindle of the first actuating drive can be articulated pivotably on the further rocker between the fourth axis of rotation and the fifth axis of rotation, wherein the transmission of the first actuating drive can be secured on the base.

The vehicle seat can be configured in such a way that the vehicle seat can assume an inclined position in which a seating surface and a seat back each have an angle of inclination relative to the longitudinal direction which allows a predominantly recumbent position of a vehicle occupant, in particular a vehicle driver, in particular in an autonomous driving mode. The vehicle seat can be transferred from the inclined position to the upright position by the occurrence of the overload, in particular crash load, acting on the vehicle seat, in that the relative movement takes place between the slide and the base.

In order, in particular, to provide the inclined position of the seat frame and of the seat back, an angle between the second (front) rocker and the seat frame can be variable by means of a second actuating drive. The second actuating drive can have an electric motor and a transmission. The second actuating drive can have an electric motor, a transmission, a spindle nut and a spindle. A spindle of the second actuating drive can be articulated, in such a way as to be pivotable eccentrically with respect to the third axis of rotation, on a connecting tube connecting the two front rockers to one another, wherein the transmission of the first actuating drive can be secured on the slide.

In particular to provide a seating surface inclination adjuster, a seating surface squab carrier can be articulated on the seat frame, in particular in such a way as to be pivotable about a sixth axis of rotation. An angle between the seating surface squab carrier and the seat frame can be settable by means of a third actuating drive.

The sixth axis of rotation can be arranged behind the first axis of rotation. The sixth axis of rotation can be arranged behind the second axis of rotation. The sixth axis of rotation can be arranged behind the third axis of rotation. The sixth axis of rotation can be arranged in front of the fourth axis of rotation. The sixth axis of rotation can be arranged in front of the fifth axis of rotation.

The base can have an adapter. The adapter can be formed or secured on a seat rail of a base designed as a longitudinal adjuster. The longitudinal adjuster can have at least the one seat rail and a floor rail, which can be connected to a vehicle floor and on which the seat rail is movably guided. The longitudinal adjuster can have a fourth actuating drive for moving the seat rail relative to the floor rail.

In particular, the adjustment kinematics system can allow an inclined position of the vehicle seat which offers increased comfort in an autonomous driving mode. By virtue of the relative movement between the slide and the further component of the vehicle seat, the vehicle seat can be transferred from the inclined position to an upright position.

The vehicle seat can furthermore have seating-surface inclination adjustability. The difference between seating-surface inclination adjustability and the provision of an inclined position consists in that, in the case of seating-surface inclination adjustment, there is a change in an angle of inclination of the seating surface, whereas an angle of inclination of the seat back is not changed, while, in the case of the adoption of an inclined position, both the angle of inclination of the seating surface and the angle of inclination of the seat back are changed.

In summary and in other words, the invention provides a vehicle seat on which part of the vehicle seat is secured on one drive for a kinematics system of an adjustment mechanism and which is designed in such a way that, in the event of a crash, it can be displaced and/or deformed passively, that is to say, for example, by a force introduced by the occupant. This ensures that the kinematics of the adjustment mechanism is reset approximately along its normal travel path without having to adjust the drive during this process. This “crash mechanism” can be triggered, for example, under force control or by active switching, e.g. by pyrotechnics or electric or magnetic actuators.

In comparison with the prior art, a vehicle seat according to the invention has the advantage of an approximately identical adjustment range in normal operation to that of adjustment kinematics systems known from the prior art. This gives rise to advantages in terms of installation space. In comparison with the prior art, quicker movements, in particular quicker transfer of the vehicle seat from the inclined position to the upright position, are possible. The blocking device has no effect on the normal operation of the vehicle seat. It is only in the event of an overload that the no longer (fully) effective blocking device requires a movement of the adjustment kinematics system.

The blocking device can be designed as a force dissipation device. The force dissipation device can have a component, in particular a bolt, which interacts with at least one force dissipation element. A blocking device designed as a force dissipation device limits the forces acting on the adjustment kinematics system in the event of an overload and preferably dissipates energy. Since the force dissipation device has a component, in particular a bolt, which interacts with at least one force dissipation element, this provides a force dissipation device, the characteristic curve of which can be selectively designed through the choice of the at least one force dissipation element.

The component can be a bolt. The component can have a round cross section. The component can have an oval cross section. The component can have a polygonal cross section. The component can be manufactured from metal. The component can be manufactured from steel. The component can be manufactured from hardened steel.

The at least one force dissipation element can be manufactured from metal. The at least one force dissipation element can be manufactured from steel. The at least one force dissipation element can be manufactured from sheet steel.

The component can be arranged in an opening in the at least one force dissipation element. At least sections of the component can be arranged in an opening in the at least one force dissipation element. The component can extend through an opening in the at least one force dissipation element.

The component can be arranged in a slotted hole in the at least one force dissipation element. At least sections of the component can be arranged in a slotted hole in the at least one force dissipation element. The component can extend through a slotted hole in the at least one force dissipation element. In one region, in particular an end region, the slotted hole can be dimensioned in such a way that it accommodates the component in a form-fitting manner, wherein the component can leave this region only by deformation of the material surrounding the slotted hole.

The component can be displaceable within an opening in the at least one force dissipation element by plastic deformation of the force dissipation element, in particular by plastic deformation of knobs on the force dissipation element.

The component can be displaceable within an opening in the at least one force dissipation element by partial breakage of the force dissipation element. The component can be displaceable in an opening in the at least one force dissipation element by breakage of at least one web of the force dissipation element.

The component can be displaceable within a conical opening in the at least one force dissipation element by plastic deformation of the force dissipation element, in particular by plastic deformation of at least one edge region of the force dissipation element.

The force dissipation device can have at least two force dissipation elements.

The force dissipation device can have at least two identical force dissipation elements. The force dissipation device can have at least two different force dissipation elements. It is thereby possible to selectively design the characteristic curves of the force dissipation device. As a preferred option, at least two force dissipation elements are arranged parallel to one another in such a way that the component can run through the two force dissipation elements simultaneously.

The force dissipation device can have two force dissipation elements, of which a first force dissipation element has a slotted hole with a height that is constant at least in some section or sections, and a second force dissipation element has a slotted hole with a height that varies at least in some section or sections.

The force dissipation device can be of modular construction. The force dissipation device can have at least one force dissipation element taken from a modular system comprising at least two different sorts of force dissipation element. The force dissipation device can have at least two force dissipation elements taken from a modular system comprising at least three sorts of different force dissipation elements.

The actuating drive or one of the two transmission elements can be connected to a slide that is connected to the base by means of a force dissipation device according to the invention, wherein, in the event of an overload, in particular a crash load, acting on the vehicle seat, the blocking device enables a relative movement between the slide and the base. In particular, the adjustment kinematics system can allow an inclined position of the vehicle seat which offers increased comfort in an autonomous driving mode. By virtue of the relative movement between the slide and the further component of the vehicle seat, the vehicle seat can be transferred from the inclined position to an upright position.

A force dissipation element of the force dissipation device can be integrated into the slide. A force dissipation element of the force dissipation device can be integrated into the slide, wherein the force dissipation device has at least one further force dissipation element, which, in particular, interacts with the component in parallel with the force dissipation element integrated into the slide.

In other words, a load reduction by deformation and or displacement of material is achieved by means of the force dissipation device. This is achieved, for example, by means of a conically tapering slotted hole, along which a bolt is forced when subjected to a load. For this purpose, various elements with various functions can be combined. For example, a further element is introduced in parallel into the load flow, using knobs or tear-off tabs to likewise dissipate energy. There are other conceivable possibilities. Examples are corrugated sheets, springs etc. By appropriate combination of these elements, it is possible to produce a particular load reduction characteristic. It is likewise conceivable to combine various elements in a single element (e.g. a conical slotted hole with additional knobs).

One advantage of a vehicle seat according to the invention that has such a force dissipation device is the capacity for selectively designed load reduction in accordance with a specifiable characteristic curve. The force dissipation device provided is less susceptible to tolerances in comparison with the prior art since it can be divided between several components (force dissipation elements). Different characteristic curves (for different vehicles, for example) can be easily achieved by a modular design of the force dissipation device (exchange and/or combination of force dissipation elements). Detailed design is possible by means of simplified equivalent load cases.

### FIGURES AND EMBODIMENTS OF THE INVENTION

The invention is explained in greater detail below by means of an advantageous exemplary embodiment illustrated in the figures and of a modified version of this exemplary embodiment. However, the invention is not restricted to this exemplary embodiment. In the drawing:

FIG. 1: shows a highly schematized side view of a vehicle seat according to the invention,

FIG. 2: shows a detail perspective view of a front part of a vehicle seat according to the invention,

FIG. 3: shows a detailed perspective view of a front part of a vehicle seat according to the invention in a modified version of the exemplary embodiment from FIG. 2, wherein three different force dissipation elements of a force dissipation device according to the invention, which can be used individually or in some cases in combination, are illustrated in an exploded view, and

FIG. 4: shows, by way of example, different force dissipation characteristic curves resulting from the use of one or more of the force dissipation elements illustrated in FIG. 3.

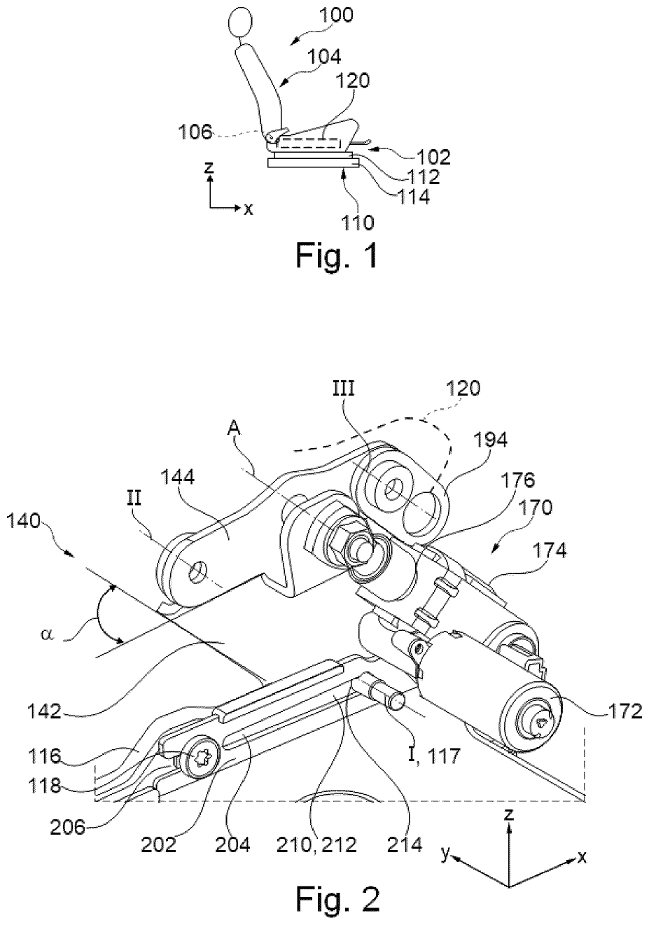

FIGS. 1 and 2 show a vehicle seat 100 according to the invention in a first exemplary embodiment, wherein the vehicle seat 100 is illustrated in highly schematized form in FIG. 1.

The vehicle seat 100 is described below using three spatial directions running perpendicular to one another. With a vehicle seat 100 installed in the vehicle, a longitudinal direction x runs largely horizontally and preferably parallel to a vehicle longitudinal direction, which corresponds to the usual direction of travel of the vehicle. In the vehicle, a transverse direction y running perpendicularly to the longitudinal direction x is likewise aligned horizontally and runs parallel to a vehicle transverse direction. A vertical direction z runs perpendicularly to the longitudinal direction x and perpendicularly to the transverse direction y. In the case of a vehicle seat 100 installed in the vehicle, the vertical direction z runs parallel to the vehicle vertical axis.

The position indications and direction indications used, e.g. front, rear, top, bottom and transversely, refer to a direction of view of an occupant sitting in a normal sitting position on a seating surface of a seat substructure 102 of the vehicle seat 100, wherein the vehicle seat 100 is installed in the vehicle in a position of use suitable for carrying people and with an upright seat back 104, and is aligned as normal in the direction of travel. However, the vehicle seat 100 may also be installed in a different alignment, e.g. transversely to the direction of travel. Unless otherwise described, the vehicle seat 100 is constructed in mirror symmetry with a plane running perpendicularly to the transverse direction y.

The vehicle seat 100 has the seat substructure 102 and the seat back 104, which is articulated with an adjustable inclination on the seat substructure 102 by means of two fittings 106. The vehicle seat 100 can be embodied as an “integrated belt seat”, in which a belt system is integrated substantially completely into the vehicle seat 100. In this case, an upper belt exit point can be integrated into an upper region of the seat back 104. However, the invention is not restricted to integrated belt seats.

The seat substructure 102 has a base 110, a seat frame 120 and an adjustment kinematics system 140 acting between the base 110 and the seat frame 120. A height adjustment function is provided by means of the adjustment kinematics system 140. In the exemplary embodiment under consideration, the adjustment kinematics system 140 also serves to provide inclination adjustment of the seat frame 120 and of a seating surface connected to the seat frame 120.

In the present case, the base 110 is a longitudinal adjuster which, on both sides, has a seat rail 112 and a floor rail 114, which can be connected to a vehicle floor and on which the seat rail 112 is movably guided. On both sides, there is an adapter 116 secured on each of the two seat rails 112. The adapter 116 is used, in particular, to attach elements of the adjustment kinematics system 140 to the base 110. The adapter 116 is thus a component of the base 110.

When considered in the transverse direction y, the seat frame 120 has a seat frame side part (not illustrated in the figures) on each of the two sides. In addition, the seat frame 120 has a front transverse tube and a rear transverse tube, neither of which is illustrated in the figures. The two seat frame side parts are arranged spaced apart.

In the exemplary embodiment under consideration (when considered in the transverse direction y) the adjustment kinematics system 140 has a five-bar kinematics system on each of the two seat sides. The two five-bar kinematics systems can be arranged in mirror symmetry with respect to one another. Here, all the pivot joints are duplicated, there being one on a right-hand seat side and one on a left-hand seat side of the vehicle seat 100 (when considered in the transverse direction y). Unless otherwise described below, therefore, all the components of the adjustment kinematics system 140 are present both on the right-hand seat side and on the left-hand seat side.

On each of the two sides, the adjustment kinematics system 140 has a first rocker 142 (a first front rocker 142 in the exemplary embodiment below) and a second rocker 144 (a second front rocker 144 in the exemplary embodiment below). In addition, the adjustment kinematics system 140 can have a further, in particular rear, rocker. Such a five-bar kinematics system is known in principle from German Patent DE 10 2016 015 170 A1, for example.

The first front rocker 142 is articulated on the base 110, in the present case the adapter 116 of the base 110, in such a way as to be pivotable about a first axis of rotation I. The second front rocker 144 is articulated on the first front rocker 142 in such a way as to be pivotable about a second axis of rotation II. The second front rocker 144 is articulated on the seat frame 120 in such a way as to be pivotable about a third axis of rotation III. A rear rocker can be articulated on the seat frame 120 in such a way as to be pivotable about a fourth axis of rotation. The rear rocker can be articulated on the base 110, in the present case the adapter 116 of the base 110, in such a way as to be pivotable about a fifth axis of rotation. The axes of rotation I, II, III run parallel to one another and parallel to the transverse direction y.

Each of the axes of rotation I, II, III runs at a distance from all of the other axes of rotation I, II, III.

To provide the height adjustment function, the adjustment kinematics system 140 can have a first actuating drive (not illustrated in the figures). By means of the first actuating drive, a distance between the base 110 and the seat frame 120 and thus between the base 110 and the seating surface can be set. For this purpose, the adjustment kinematics system 140 can be set in such a way, by means of actuation of the first actuating drive, that an angle between the first front rocker 142 and the base 110, an angle o between the first front rocker 142 and the second front rocker 144, an angle between the seat frame 120 and the rear rocker, and an angle between the rear rocker and the base 110 can be varied, wherein an angle between the second front rocker 144 and the seat frame 120 remains constant as long as a further actuating drive 170 for the provision of the inclination adjustment of the seat frame 120, referred to below as the second actuating drive 170, remains unactuated.

The two rear rockers can be connected for conjoint rotation, in particular welded, to a rear transverse tube. The rear transverse tube and thus the two rear rockers can be mounted on the seat frame side parts of the seat frame 120 in such a way as to be pivotable about the fourth axis of rotation.

The first actuating drive can have an electric motor, a transmission, a spindle nut and a spindle. The spindle nut can be a rotatable and drivable component part of the transmission and can preferably be arranged in a transmission housing of the transmission. The first actuating drive can connect the rear rocker and the base 110 to one another at an adjustable angle and preferably directly, i.e. not via further transmission elements of the adjustment kinematics system 140. For this purpose, the spindle can be articulated on the rear rocker eccentrically with respect to the fifth axis of rotation. The motor and the transmission can be connected in a fixed manner to the adapter 116 of the base 110. The spindle nut can be rotated by actuating the motor, with the result that the spindle is moved relative to the transmission, and the rear rocker pivots.

To provide the inclination adjustment of the seat frame 120 and of the seat back 104, the adjustment kinematics system 140 has the second actuating drive 170. By means of the second actuating drive 170, the angle between the second front rocker 144 and the seat frame 120 can be set, wherein the angle between the rear rocker and the base 110 preferably remains constant as long as the first actuating drive remains unactuated. By means of the second actuating drive 170, the seat frame 120 can be raised in its front region and pivoted about the fourth axis of rotation. Together with the seat frame 120, the seat back 104 articulated on the seat frame 120 by means of the fittings 106 is pivoted backward, in the present case about the fourth axis of rotation, thus providing the inclined position of the seat frame 120 and of the seat back 104 and thus of the vehicle seat 100.

In the inclined position, the seat frame 120 and the seat back 104 are each inclined backwards relative to an upright position about an axis parallel to the transverse direction y (the fourth axis of rotation in the exemplary embodiment), with the result that a largely recumbent position of the vehicle driver during an autonomous driving mode is enabled. The upright position of the vehicle seat 100 corresponds to a seat adjustment in which the vehicle driver can safely take over vehicle guidance if the autonomous driving mode is switched off.

The first actuating drive can optionally be omitted. To this extent, the second actuating drive 170 may also be the only actuating drive.

The second actuating drive 170 has an electric motor 172, a transmission 174, a spindle nut and a spindle 176. The second actuating drive 170 connects one of the two second front rockers 144 at an adjustable angle to a slide 202. The two second front rockers 144 are preferably connected to one another by means of a connecting tube. The connecting tube runs parallel to but at a distance from the second axis of rotation II and the third axis of rotation III.

The spindle 176 of the second actuating drive 170, in particular an end region of the spindle 176, is connected to the second front rocker 144, preferably in such a way as to be pivotable about an articulation axis A. The articulation axis A can be arranged between the second axis of rotation II and the third axis of rotation III. The transmission 174 is connected to the slide 202.

In the normal mode of the vehicle seat 100, the slide 202 is connected in a fixed manner to the base 110. However, the slide 202 is movable to a limited extent relative to the base 110 under a high load (in particular a crash load). By means of this relative movement between the slide 202 and the base 110, the adjustment of the adjustment kinematics system 140 can be changed via the second actuating drive 170 without the need to actuate the electric motor 172 of the second actuating drive 170.

The slide 202 is mounted with the ability for limited movement relative to the base 110. In the present case, the slide 202 has a slotted hole 204 and a fork 206 for this purpose. The slotted hole 204 runs largely parallel to the longitudinal direction x. The fork 206 is a rearwardly open slot, which likewise runs largely parallel to the longitudinal direction x. A bolt 117 connected in a fixed manner to the base 110 is arranged within the slotted hole 204. The bolt 117 is aligned with the first axis of rotation I. A screw 118 connected in a fixed manner to the base 110 is arranged within the fork 206.

The slide 202 is arranged in such a way relative to the base 110 that the bolt 117 rests against a front edge region of the slotted hole 204, and the screw 118 is arranged in the fork 206.

In a normal mode of the vehicle seat 100, the slide 202 is secured against movement relative to the base 110 by means of a blocking device 210. For this purpose, a predetermined breaking component 212 can be arranged in the slotted hole 204, for example. The predetermined breaking component 210 closes the slotted hole 204, thus preventing the slotted hole 204 from being moved relative to the vault 117.

In the event of an overload, in particular a crash load with a force component acting in the longitudinal direction x, on the vehicle seat 100, the blocking device 210 opens, thus enabling the slide 202 to be moved relative to the base 110. For example, the forces acting on the predetermined breaking component 210 are so high that the predetermined breaking component 210 breaks and thereby enables movement of the slide 202 relative to the base 110. Alternatively or in addition to the predetermined breaking component 210, the slotted hole 204 can have a constriction 214, through which the bolt 117 can be guided only after plastic deformation.

During the relative movement between the slide 202 and the adapter 116 of the base 110, a distance between the articulation axis A and the point of attachment of the transmission 174 to the slide 202 remains constant. The adapter 116 of the base 110 and thus the first axis of rotation I of the first front rocker 142 are not moved at the same time, and therefore the articulation axis A is pulled downward by the spindle 176. As a result, the angle o between the first front rocker 142 and the second front rocker 144 is changed, in the present case reduced, with the result that the seat frame 120 and the seat back 104 are pivoted, in the present case about the fourth axis of rotation, out of the inclined position in the direction of the upright position without the need to activate the (second) actuating drive 170.

To provide a seating surface inclination adjuster, the vehicle seat 100 can have a third actuating drive (not illustrated in the figures). A seating surface squab carrier (not illustrated in the figures) carries a squab, which has a seating surface for an occupant of the vehicle 100. By means of the seating surface inclination adjuster, an angle between the seating surface and the longitudinal direction x can be set without changing the angle of the seat back 104 relative to the vertical direction z during this process.

The third actuating drive can have an electric motor, a transmission, a spindle nut and a spindle. The third actuating drive can connect the seat frame 120 and a supporting tube (not illustrated in the figures) to one another at an adjustable angle and preferably directly, i.e. not via further transmission elements. The supporting tube can be articulated on the seat frame 120 by means of an eccentric plate 194 in such a way as to be pivotable eccentrically about the third axis of rotation III.

The seating surface squab carrier can be a seat shell, for example, in particular a seat shell made of a deep drawn metal sheet or a plastic. The seating surface squab carrier can be articulated on the seat frame 120 in such a way as to be pivotable about a sixth axis of rotation. In addition, the seating surface squab carrier can rest pivotably on the supporting tube. The supporting tube can be arranged in front of the sixth axis of rotation (when considered in the longitudinal direction x).

If the seating surface squab carrier is articulated on the seat frame 120 in such a way as to be pivotable about the sixth axis of rotation, and the supporting tube is pivotable eccentrically with respect to the seat frame 120, in the present case about the third axis of rotation III, by means of the third actuating drive, an angle between the seating surface squab carrier and thus the seating surface and the seat frame 120 can be set by means of the third actuating drive.

A fourth actuating drive can be used for longitudinal adjustment, that is to say to move the seat rail 112 relative to the floor rail 114.

The vehicle seat 100 is largely mirror-symmetrical with respect to a plane running perpendicularly to the transverse direction y and, in particular, has a second actuating drive 170, preferably also a first actuating drive and a fourth actuating drive, on each of the two sides.

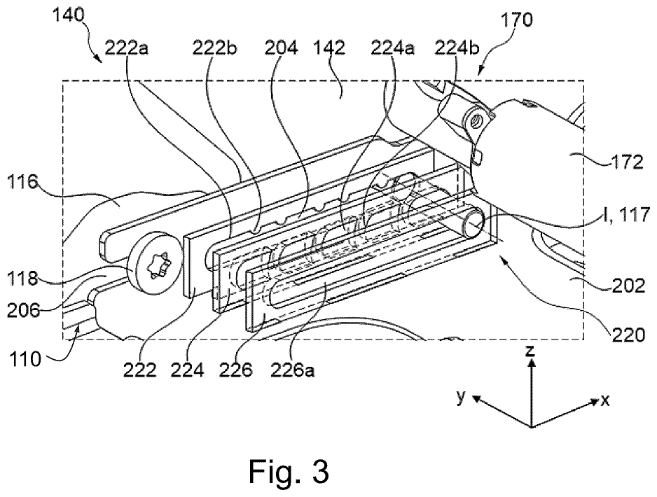

FIG. 3 shows a modified version of the vehicle seat 100 according to the invention. In terms of construction and functioning, the modified version of the vehicle seat 100 according to the invention corresponds to the above-described vehicle seat 100 unless otherwise described below.

In the present case, a base 110 is a longitudinal adjuster which, on both sides, has a seat rail 112 and a floor rail 114, which can be connected to a vehicle floor and on which the seat rail 112 is movably guided. On both sides, there is an adapter 116 secured on each of the two seat rails 112. The adapter 116 is used, in particular, to attach elements of an adjustment kinematics system 140 to the base 110. The adapter 116 is thus a component of the base 110.

When considered in the transverse direction y, the seat frame 120 has a seat frame side part on each of the two sides. In addition, the seat frame 120 has a front transverse tube and a rear transverse tube, neither of which is illustrated in the figures. The two seat frame side parts are arranged spaced apart.

In the present case, the adjustment kinematics system 140 has a five-bar kinematics system (illustrated only as a detail in FIG. 3) with a first front rocker 142, a second front rocker and a rear rocker on each of the two sides (when considered in the transverse direction y). Such a five-bar kinematics system is known in principle from German Patent DE 10 2016 015 170 A1, for example.

The two five-bar kinematics systems can be arranged in mirror symmetry with respect to one another. Here, all the pivot joints are duplicated (one for each five-bar kinematics system), there being one on a right-hand seat side and one on a left-hand seat side of the vehicle seat 100 (when considered in the transverse direction y).

Unless otherwise described below, all the components of the adjustment kinematics system 140 are present both on the right-hand seat side and on the left-hand seat side.

The first front rocker 142 is articulated on the base 110, in the present case the adapter 116 of the base 110, in such a way as to be pivotable about a first axis of rotation I. The second front rocker is articulated on the first front rocker 142 in such a way as to be pivotable about a second axis of rotation. The second front rocker is articulated on the seat frame 120 in such a way as to be pivotable about a third axis of rotation. The rear rocker is articulated on the seat frame 120 in such a way as to be pivotable about a fourth axis of rotation. The rear rocker is articulated on the base 110, in the present case the adapter 116 of the base 110, in such a way as to be pivotable about a fifth axis of rotation. The axes of rotation run parallel to one another and parallel to the transverse direction y. Each of the axes of rotation runs at a distance from all of the other axes of rotation.

To provide the height adjustment function, the adjustment kinematics system 140 can have a first actuating drive (not illustrated in the figures). By means of the first actuating drive, a distance between the base 110 and the seat frame 120 can be set. For this purpose, the adjustment kinematics system 140 can be set in such a way, by means of actuation of the first actuating drive, that an angle between the first front rocker 142 and the base 110, an angle between the first front rocker 142 and the second front rocker, an angle between the seat frame 120 and the rear rocker, and an angle between the rear rocker and the base 110 can be varied, wherein an angle between the second front rocker and the seat frame 120 remains constant as long as a further actuating drive 170 for the provision of the inclination adjustment of the seat frame 120, referred to below as the second actuating drive 170, remains unactuated. The two rear rockers can be connected for conjoint rotation, in particular welded, to a rear transverse tube. The rear transverse tube and thus the two rear rockers can be mounted on the seat frame side parts of the seat frame 120 in such a way as to be pivotable about the fourth axis of rotation.

The first actuating drive can have an electric motor, a transmission, a spindle nut and a spindle. The spindle nut can be a rotatable and drivable component part of the transmission and can preferably be arranged in a transmission housing of the transmission. The first actuating drive can connect the rear rocker and the base 110 to one another at an adjustable angle and preferably directly, i.e. not via further transmission elements of the adjustment kinematics system 140. For this purpose, the spindle can be articulated on the rear rocker eccentrically with respect to the fifth axis of rotation. The motor and the transmission can be connected in a fixed manner to the adapter 116 of the base 110. The spindle nut can be rotated by actuating the motor, with the result that the spindle is moved relative to the transmission, and the rear rocker pivots.

To provide the inclination adjustment of the seat frame 120 and of the seat back 104, the adjustment kinematics system 140 has the second actuating drive 170. By means of the second actuating drive 170, the seat frame 120 can be raised in its front region and pivoted about the fourth axis of rotation. By means of the second actuating drive 170, the angle between the second front rocker and the seat frame 120 can be set, although the angle between the rear rocker and the base 110 preferably remains constant as long as the first actuating drive remains unactuated. Together with the seat frame 120, the seat back 104 articulated on the seat frame 120 by means of the fittings 106 is pivoted backward, in the present case about the fourth axis of rotation, thus providing the inclined position of the seat frame 120 and of the seat back 104 and thus of the vehicle seat 100.

The second actuating drive 170 has an electric motor 172, a transmission 174, a spindle nut and a spindle. The second actuating drive 170 connects one of the two second front rockers at an adjustable angle to a slide 202. The two second front rockers are preferably connected to one another by means of a connecting tube. The connecting tube runs parallel to but at a distance from the second axis of rotation and the third axis of rotation.

The spindle of the second actuating drive 170, in particular an end region of the spindle, is connected to the second front rocker, preferably in such a way as to be pivotable about an articulation axis. The articulation axis can be arranged between the second axis of rotation and the third axis of rotation. The transmission 174 is connected to the slide 202.

In the normal mode of the vehicle seat 100, the slide 202 is connected in a fixed manner to the base 110. However, the slide 202 is movable to a limited extent relative to the base 110 under a high load (in particular a crash load). By means of this relative movement between the slide 202 and the base 110, the adjustment of the adjustment kinematics system 140 can be changed via the second actuating drive 170 without the need to actuate the electric motor 172 of the second actuating drive 170.

In the present case, the slide 202 has a slotted hole 204 and a fork 206. The slotted hole 204 runs largely parallel to the longitudinal direction x. The fork 206 is a rearwardly open slot, which likewise runs largely parallel to the longitudinal direction x. A bolt 117 connected in a fixed manner to the base 110 is arranged within the slotted hole 204 in an end region of the slotted hole 204. In the present case, the bolt 117 is aligned with the first axis of rotation I. The bolt 117 can simultaneously be the bearing bolt of the first front rocker 142.

An end region of the slotted hole 204 remote from the fork 206 preferably has a contour in the form of a circular arc with a diameter which corresponds to the diameter of the bolt 117, thus ensuring that the slide 202 is held on the bolt 117 by the contour in the form of a circular arc during a normal mode of the vehicle seat 100. The remaining region of the slotted hole 204 preferably has a constant height (perpendicularly to the longitudinal direction x) which is smaller than the diameter of the bolt 117, and therefore the slotted hole 204 can slide along the bolt 117 only by plastic deformation of the material around the slotted hole 204. A screw 118 connected in a fixed manner to the base 110 is arranged within the fork 206 and additionally secures the slide 202 on the base 110 in a normal mode of the vehicle seat 100.

The slotted hole 204 and the bolt 117 arranged therein are components of a blocking device designed as a force dissipation device 220. The force dissipation device 220 serves to ensure selective force dissipation by deformation and/or displacement of material and/or to ensure selective movements, in particular of the adjustment kinematics system 140 of the vehicle seat 100, in the event of an overload. By means of the force dissipation, components of the vehicle seat 100 can be protected from excessive loads. In the present case, the term force dissipation also includes energy dissipation because the force dissipation takes place with a relative movement between the bolt 117 and the slotted hole 204.

In addition to the slotted hole 204 and the bolt 117 arranged therein, the force dissipation device 220 preferably comprises at least one further force dissipation element 222; 224; 226, which is arranged next to the slotted hole 204 in such a way that the bolt 117 also projects through the at least one force dissipation element 222; 224; 226.

In the event of an overload, in particular a crash load with a force component acting in the longitudinal direction x, on the vehicle seat 100, the slide 202 moves along the base 110, wherein the slotted hole 204 and the at least one force dissipation element 222; 224; 226 are deformed and/or destroyed by the bolt 117 since the bolt 117 undergoes a relative movement within the slotted hole 204.

FIG. 3 illustrates a first force dissipation element 222, a second force dissipation element 224 and a third force dissipation element 226 side-by-side in an exploded representation. A force dissipation device 220 according to the invention has at least one or more of these force dissipation elements 222; 224; 226. Individual force dissipation elements 222; 224; 226 may also be combined with one another in order to provide force dissipation devices 220 with defined force dissipation characteristic curves. The bolt 117 preferably projects through the slotted hole 204, which in the present case preferably likewise acts as a force dissipation element, and the respectively used force dissipation elements 222; 224; 226.

The first force dissipation element 222 has an opening 222a in the form of a slotted hole, and a plurality of knobs 222b. The knobs 222b project into the opening 222a in such a way that the bolt 117 can be moved within the opening 222a and along the slotted hole 204 only by deformation of the knobs 222b.

The second force dissipation element 224 has an opening 224a in the form of a slotted hole, and a plurality of webs 224b. The webs 224b divide the opening 224a into a plurality of partial regions, such that the bolt 117 can be moved within the opening 224a and along the slotted hole 204 only by destruction of the webs 224b.

The third force dissipation element 226 has an opening 226a in the form of a slotted hole, wherein the opening 226a is of conical design, such that the bolt 117 can be moved within the opening 226a and along the slotted hole 204 only with increasing friction and increasing deformation.

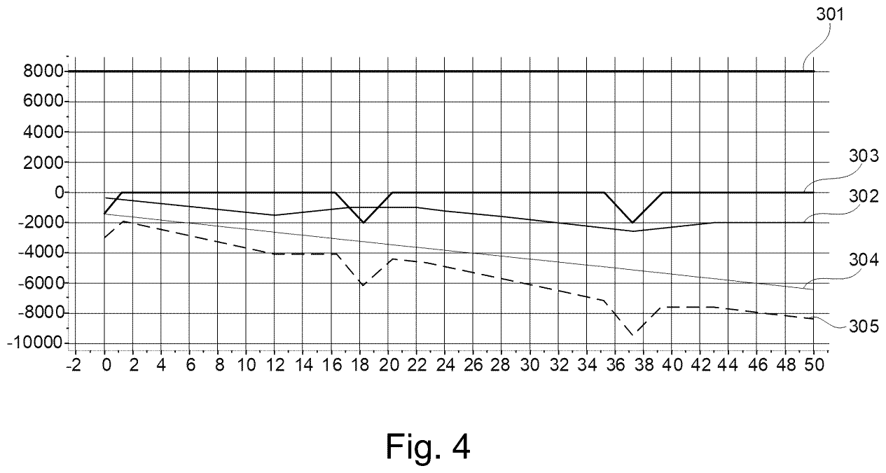

FIG. 4 illustrates a diagram with different force dissipation characteristic curves 301; 302; 303; 304; 305, wherein force dissipation characteristic curves 302; 303; 304; 305 can each be achieved by using individual or different combinations of the force dissipation elements 222; 224; 226 illustrated in FIG. 2. The force dissipation characteristic curves 301; 302; 303; 304; 305 show a force F (in N) acting in the longitudinal direction x, e.g. on the bolt 117, as a function of a movement s (in mm) of the bolt 117 in the longitudinal direction x in the slotted hole 204. The numerical values stated in the diagram in FIG. 3 are only illustrative and may differ significantly depending on the design/use of the invention.

Force dissipation characteristic curve 301 represents, in idealized and illustrative form, a force profile of the kind that results from the slotted hole 204 without the use of a further force dissipation element 222; 224; 226.

Force dissipation characteristic curve 302 shows a force profile which is modified relative to force dissipation characteristic curve 301 and which results from the use of a force dissipation element 224 that has webs 224b, said profile pulsating.

Force dissipation characteristic curve 303 shows a force profile which is modified relative to force dissipation characteristic curve 301 and which results from the use of a force dissipation element 222 that has knobs 222b, said profile exhibiting an effect on the force at certain points.

Force dissipation characteristic curve 304 shows a force profile which is modified relative to force dissipation characteristic curve 301 and which results from the use of a force dissipation element 226 with a conical opening 226a in the form of a slotted hole, said profile being linear.

Force dissipation characteristic curve 305 shows a force profile which is modified relative to characteristic curve 301 and which results from a combination of a force dissipation element 224 that has webs 224b and of a force dissipation element 226 with a conical opening 226a in the form of a slotted hole.

In the present case, the slotted hole 204 is provided in the slide 202, and at least one force dissipation element 222; 224; 226 is formed separately from the slide 202. In the region of the slotted hole 204, the slide 202 likewise acts as a force dissipation element.

In another modified version of the exemplary embodiment, the slotted hole is not formed in the slide but is an integral component of a further force dissipation element. In another modified version of the exemplary embodiment, the slotted hole is not formed in a slide but in some other component of the vehicle seat. The slide can also be integrated into some other component of the vehicle seat, or other components of a vehicle seat can be designed as a slide. A force dissipation device according to the invention is thus suitable for different uses in vehicle seats insofar as, in the event of an overload, forces on components need to be limited or dissipated or motion sequences of components of the vehicle seat are to be selectively influenced.

In a normal mode of the vehicle seat 100, the slide 202 is secured against movement relative to the base 110 by means of the blocking device designed as a force dissipation device 220. In the event of an overload, a movement of the slide 202 relative to the base 110 may occur. Owing to the movement between the slide 202 and the base 110, forces on components of the vehicle seat 100 and/or on an occupant are reduced. In addition, the angle between the first front rocker 142 and the second front rocker is changed, in the present case reduced, with the result that the seat is pivoted out of the inclined position in the direction of the upright position without the need to activate the second actuating drive 170.

The features disclosed in the above description, the claims and the figures may be significant, both individually and in combination, for the implementation of the invention in its various embodiments, insofar as they remain within the scope of protection of the claims.

### LIST OF REFERENCE SIGNS

100 vehicle seat
102 seat substructure
104 seat back
106 fitting
110 base
112 seat rail
114 floor rail
116 adapter
117 bolt
118 screw
120 seat frame
140 adjustment kinematics system
142 first (front) rocker
144 second (front) rocker
170 (second) actuating drive
172 electric motor
174 transmission
176 spindle
194 eccentric plate
202 slide
204 slotted hole
206 fork
210 blocking device
212 predetermined breaking component
214 constriction
220 force dissipation device
222 (first) force dissipation element
222a opening
222b knob
224 (second) force dissipation element
224a opening
224b web
226 (third) force dissipation element
226a opening
301 force dissipation characteristic curve
302 force dissipation characteristic curve
303 force dissipation characteristic curve
304 force dissipation characteristic curve
305 force dissipation characteristic curve
α angle
I first axis of rotation
II second axis of rotation
III third axis of rotation
A articulation axis
F force
s movement
x longitudinal direction
y transverse direction
z vertical direction

1-15. (canceled)

16. A vehicle seat for an autonomously driving motor vehicle, comprising an adjustment kinematics system, the adjustment kinematics system comprising a first transmission element and a second transmission element, which are pivotable relative to one another by means of an actuating drive,
characterized in that
the actuating drive or one of the two transmission elements is connected to a slide, wherein a blocking device locks the slide relative to a base of the vehicle seat, and, in the event of an overload acting on the vehicle seat, the blocking device enables a relative movement between the slide and the base of the vehicle seat.

17. The vehicle seat as claimed in claim 16, characterized in that the vehicle seat has a seat substructure and a seat back articulated on the seat substructure,
wherein the seat substructure has the base, a seat frame and an adjustment kinematics system acting between the base and the seat frame.

18. The vehicle seat as claimed in claim 16, characterized in that the first transmission element is designed as a first front rocker.

19. The vehicle seat as claimed in claim 18, characterized in that the second transmission element is designed as a second front rocker, which is pivotable relative to the first front rocker by means of the actuating drive.

20. The vehicle seat as claimed in claim 19, characterized in that the actuating drive or one of the two front rockers is connected to a slide that is locked by the blocking device, wherein, in the event of an overload acting on the vehicle seat, the blocking device enables a relative movement between the slide and the base.

21. The vehicle seat as claimed in claim 17, characterized in that the vehicle seat is transferred from an upright position into an inclined position, in which the seat frame and the seat back each have an angle of inclination relative to a longitudinal direction which allows a predominantly recumbent position of a vehicle occupant in an autonomous driving mode.

22. The vehicle seat as claimed in claim 21, characterized in that the vehicle seat is transferred from the inclined position to the upright position by the occurrence of the overload acting on the vehicle seat in that the relative movement takes place between the slide and the base.

23. The vehicle seat as claimed in claim 19, characterized in that the first front rocker is articulated on an adapter of the base in such a way as to be pivotable about a first axis of rotation, the second front rocker is articulated on the first front rocker in such a way as to be pivotable about a second axis of rotation, and the second front rocker is articulated on the seat frame in such a way as to be pivotable about a third axis of rotation.

24. The vehicle seat as claimed in claim 23, characterized in that a rear rocker is articulated on the seat frame in such a way as to be pivotable about a fourth axis of rotation, and is articulated on the adapter of the base in such a way as to be pivotable about a fifth axis of rotation.

25. The vehicle seat as claimed in claim 16, characterized in that the blocking device is designed as a force dissipation device having a bolt which interacts with at least one force dissipation element.

26. The vehicle seat as claimed in claim 25, characterized in that at least sections of the component are arranged in an opening in the at least one force dissipation element, and the component is displaceable within the opening by plastic deformation of the force dissipation element.

27. The vehicle seat as claimed in claim 26, characterized in that the component is displaceable within the opening in the force dissipation element by plastic deformation of knobs on the force dissipation element.

28. The vehicle seat as claimed in claim 26, characterized in that the component is displaceable within the opening in the force dissipation element by partial breakage of at least one web of the force dissipation element.

29. The vehicle seat as claimed in claim 26, characterized in that the component is displaceable in a conical opening in the force dissipation element by plastic deformation of at least one edge region of the force dissipation element.

30. The vehicle seat as claimed in claim 25, characterized in that the force dissipation device has at least two force dissipation elements with which the component interacts.
